(19) United States
(12) Patent Application Publication
(10) Pub. No.: US 2018/0308065 A1
(43) Pub. Date: Oct. 25, 2018

(54) AUTOMATICALLY PRESENTING ONE OR MORE CALENDARS BASED ON USER BEHAVIOR

(71) Applicant: Microsoft Technology Licensing, LLC, Redmond, WA (US)

(72) Inventors: Manjot Singh PAL, Seattle, WA (US); Shahil SONI, Seattle, WA (US)

(73) Assignee: Microsoft Technology Licensing, LLC, Redmond, WA (US)

(21) Appl. No.: 15/491,503

(22) Filed: Apr. 19, 2017

(51) Int. Cl. G06Q 10/10; G06F 3/0481

(52) U.S. Cl. CPC G06Q 10/1095; G06F 3/0481

(57) ABSTRACT

Methods and systems are disclosed for selectively displaying one or more of a plurality calendars that are applicable to a user at a given time based on monitoring user behavior. For instance, user interactions directly with calendars or events, and/or indirectly with related activities such as web browsing, may be monitored to identify patterns of user behavior. Rules may be generated based on the patterns of user behavior for determining when to automatically display one or more calendars of the plurality of calendars. For instance, based at least in part on application of the rules, calendars that are applicable to a user at particular times may be selected for display.

### BACKGROUND

Use of electronic calendars to manage both personal and professional events has become common. Many users prefer to use more than one calendar to separately manage different series of events. For example, a user may maintain one calendar for work-related events, such as meetings and project activities; another calendar for private events, such as those related to children's school activities or family anniversary events; and yet another calendar for sports or hobby events that one may be interested in playing and/or watching.

At any given point of time, there may be some events that are included in respective calendars with different contexts of activities. One may individually select different calendars of interest to display events for the given point of time, typically based on the context of the activities applicable to the user at that time. For instance, people in a work context would prefer to see work-related events on their calendars during work hours. However, issues may arise if one fails to view each of the calendars that includes events at the given time, resulting in missing or being late to important events; alternatively, the user may become overwhelmed toggling back and forth between each of the potentially applicable calendars, resulting in wasted time and/or unnecessary delay in determining potentially conflicting events at the given time.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

According to the present disclosure, the above and other issues may be resolved by selecting which of a plurality of calendars should be displayed at particular times based on how a user interacts with the calendars and events therein. For example, user interactions may be monitored, including user interactions such as selecting or de-selecting one or more of the plurality of calendars or events therein and/or creating, modifying and/or deleting one or more events associated with one or more calendars. Additionally, user interactions other than interactions with one or more calendars may be monitored, such alternative user interactions may include searching for particular topics on the web using a web browser, interacting with software applications other than calendaring applications (e.g., task applications, messaging applications, productivity applications, customer relationship management (CRM) applications, line of business (LOB) applications, etc.), and the like. Such alternative user interactions may then be evaluated to determine whether the user interactions are related to one or more calendars and/or one or more events, e.g., whether the topics searched are related to a calendar and/or event, whether a message sent is related to a calendar and/or event, etc. Based on monitoring the user interactions, rules may be generated for determining whether one or more particular calendars of the plurality of calendars is likely to be applicable to a user at a particular time. Based on the determination, the one or more particular calendars determined to be applicable may be displayed to the user at the particular time.

In aspects, a computer-implemented method of selectively displaying one or more calendars is provided. The method includes receiving an indication to configure a plurality of calendars, where each calendar is associated with one or more events. The method further includes monitoring one or more user interactions over a monitored period of time and generating a rule based at least in part on the monitored one or more user interactions over the monitored period of time. Based at least in part on the rule, selecting at least one of the plurality of calendars for display over a display period.

In further aspects, a computing system including a processor and a memory storing computer-executable instructions is provided. The computer-executable instructions when executed by the processor cause the computing system to monitor a number of user interactions with a calendar of a plurality of calendars over a monitored time period and determine whether the number of user interactions during the monitored time period is greater than or equal to a threshold. When the number of user interactions is greater than or equal to the threshold, the computer-executable instructions further cause the computing system to select the calendar of the plurality of calendars for display over a display period.

In still further aspects, a computer storage medium is provided. The computer storage medium includes computer-executable instructions that when executed by a processor perform a method of selectively displaying one or more calendars. The method includes receiving an indication to configure a plurality of calendars and monitoring one or more user interactions over a monitored time period. The method further includes determining whether the one or more user interactions are related to a calendar of the plurality of calendars and, based at least in part on determining that the one or more user interactions are related to the calendar, selecting the calendar for display over a display period.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates a method for automatically displaying one or more of multiple calendars during a display period based on rules derived from monitoring user interactions, according to an example embodiment.

FIG. 2 illustrates a method for automatically displaying one or more calendars during a calendar period based on monitoring user-configured calendar events for calendar period, according to an example embodiment.

FIGS. 3A and 3B depict a graphical user interface displaying multiple calendars, according to an example embodiment.

FIG. 4 illustrates a graphical user interface for displaying and updating a calendar event, according to an example embodiment.

FIG. 5 illustrates a method for selectively displaying calendars based on user interactions with computing devices.

FIGS. 6A and 6B illustrate block diagrams illustrating example physical components of a computing device with which aspects of the disclosure may be practiced.

FIGS. 7A and 7B are simplified block diagrams of a mobile computing device with which aspects of the present disclosure may be practiced.

FIG. 8 is a simplified block diagram of a distributed computing system in which aspects of the present disclosure may be practiced.

FIG. 9 illustrates a tablet computing device for executing one or more aspects of the present disclosure.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, entirely a software implementation or an implementation combining software and hardware aspects. The following detailed description is, therefore, not to be taken in a limiting sense.

Systems and methods are disclosed to automatically select one or more calendars of a plurality of calendars for display at a specific time based on monitored user behavior and/or identified usage patterns. As use of electronic calendars on computing devices has become commonplace, users often create and maintain multiple calendars to manage different aspects of their daily schedules and lives. For example, some calendars may be specific to a work context while other calendars may be associated with non-work contexts, such as personal, family, sports, education, hobbies, and others. Users who maintain multiple calendars often prefer to selectively display a subset of the multiple calendars (e.g., one or more of the multiple calendars) associated with one or more particular contexts that are relevant or applicable at a given time. For example, during daytime hours of a weekday, a user may wish to display a calendar associated with a work context. Alternatively, during evening hours of a weekday and/or on weekends, a user may wish to display three calendars, one associated with sports, one associated with family and one associated with hobbies.

In aspects, a computing device may support the configuration, selection, modification and display of multiple calendars, including the events contained therein. However, issues may arise when a user has configured too many calendars. For instance, a user may fail to view each of the calendars at a given time, resulting in missing or being late to important events; alternatively, the user may become overwhelmed toggling back and forth between multiple potentially applicable calendars, resulting in unnecessary delay or frustration in determining potentially conflicting events at the given time. For example, a user may opt to display calendars that are work-related while at work, but may forget to view a personal calendar that includes an important family event taking place during a lunch time. In this case, if the user does not remember to select the personal calendar, the family event will not be displayed on the computing device. As should be appreciated, users who choose to maintain multiple calendars are in need of a system that automatically detects events across the multiple calendars and/or automatically displays particular calendars determined to be applicable to the user at particular times. In this way, such users will be able to continue maintaining separate calendars while not being burdened with thinking about which calendars are applicable at which times, thereby saving time and preventing missed appointments and events.

Aspects of the present disclosure solve these issues by monitoring and evaluating user interactions with a plurality of calendars and associated events, as well as user interactions with search functions (e.g., via a web browser) associated with topics that are relevant to events in particular calendars. For example, rules may be created for prioritizing calendars at different times based on usage patterns identified by analyzing the user interactions. Then, at any moment of time, one or more calendars of the plurality of calendars, along with any associated events, that are determined highest in priority may be automatically selected and displayed to the user. Moreover, display of multiple high-priority calendars may be merged, overlaid, or otherwise combined such that the user may be able to view events associated with each of the high-priority calendars substantially simultaneously.

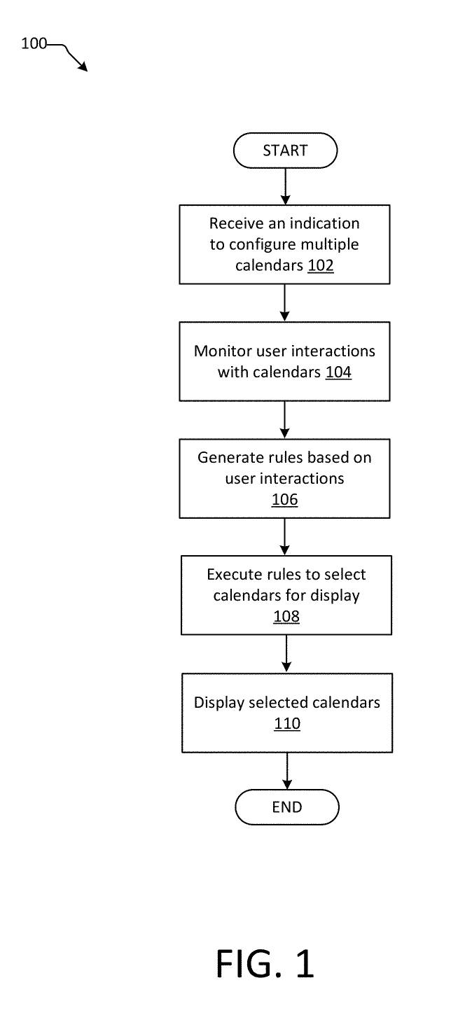

FIG. 1 illustrates a method 100 for automatically displaying one or more of multiple calendars based on rules derived from monitoring user interactions, according to an example embodiment.

At receive operation 102, an indication may be received to configure multiple calendars. Such an indication, for example, may be a command generated by a user launching a calendar program or a clock that signals the system to update calendar configurations.

At monitor operation 104, user interactions with one or more of the multiple calendars may be monitored and/or recorded. For example, user interactions may be monitored and/or recorded when a user creates, opens, modifies, or deletes a calendar event associated with a calendar. As should be appreciated, a calendar event (or “event”) may include an appointment, a reminder, a meeting, a social activity, a sporting activity, a work trip, a personal vacation, and the like. Additionally or alternatively, user interactions may be monitored and/or recorded when a user selects (e.g., launches, opens, views, etc.) a particular calendar of the multiple calendars.

The monitoring may take place over a variety of time periods to effectively capture user behavior with respect to the multiple calendars. In addition to monitoring time periods during which particular calendars are selected, in some examples, the system may monitor time periods during which particular calendars are not selected. In some examples, user interactions with events and calendars may be continuously monitored, e.g., second-by-second, minute-by-minute, etc., during each day of a week within a month of a year. Alternatively, user interactions may be monitored over any measurable period of time (e.g., 33 minutes between 2:00 PM and 2:33 PM). Alternatively still, user interactions may be monitored over different relative time increments, e.g., evening hours (e.g., 5 PM to 10 PM), late-night hours (e.g., 10 PM to 2 AM), early-morning hours (e.g., 5 AM to 7 AM), morning hours (e.g., 7 AM to 9 AM), daytime hours (e.g., 8 AM to 5 PM), work hours (e.g., 7:30 AM to 5:30 PM), a particular time during the day (e.g., 10 AM), a particular hour during a particular day of the week (e.g., 9 AM to 10 AM on Mondays), a particular day of the week (e.g., Tuesdays), a weekday or a weekend day, a particular week of a month (e.g., second week), a particular month (e.g., April), and the like. As should be appreciated, one or more monitoring time periods corresponding to one or more relative increments of time may be defined in any suitable way. In some examples, user interactions may be monitored for a specific set of calendars selected for monitoring by a user or an administrator.

At generate rules operation 106, one or more rules may be generated for prioritizing calendars at different times. In aspects, the rules are generated based on usage patterns identified by analyzing the user interactions with the multiple calendars and/or events. In some examples, there may be a graphical user interface for a user to create, modify and/or delete the rules. Examples of rules may include, but are not limited to, one or more of: prioritizing one or more calendars that a user has selected (e.g., launched, opened, viewed) more than a threshold number of times over a threshold number of hours (e.g. selected more than five times during the past 24 hours), prioritizing one or more calendars that a user selected more than a threshold number of times during a monitored time period (e.g., selected more than three times during evening hours on Mondays), prioritizing one or more calendars with which a user interacted (e.g., modified, viewed, deleted, etc.) one or more events a threshold number of times during a calendar period (e.g., viewed an event on a particular calendar during early-morning hours for the past three Tuesdays).

At execute rules operation 108, the one or more rules may be executed to prioritize one or more calendars of the multiple calendars and to select the one or more prioritized calendars for display at different periods of time. In some examples, rules may be executed so as to automatically display one or more prioritized calendars that are applicable to a user even when the user has not manually specified display of the one or more prioritized calendars.

At display operation 110, the one or more prioritized calendars may be automatically displayed at a given time. In aspects, when more than one calendar is selected for display, the calendars may be merged, overlaid, or otherwise combined such that the user may view events associated with each of the high-priority calendars substantially simultaneously.

In some examples, a display period may be determined based on various conditions for selectively displaying one or more of the prioritized calendars. Such conditions may include, but are not limited to, displaying each prioritized calendar until a first event of the calendar ends, displaying each prioritized calendar for a particular time period (e.g., corresponding to a monitored time period, such as during evening hours on Mondays, from 9 AM to 10 AM on Tuesdays, over the weekend, etc.), or displaying each prioritized calendar for a user specified display period.

As should be appreciated, operations 102-110 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

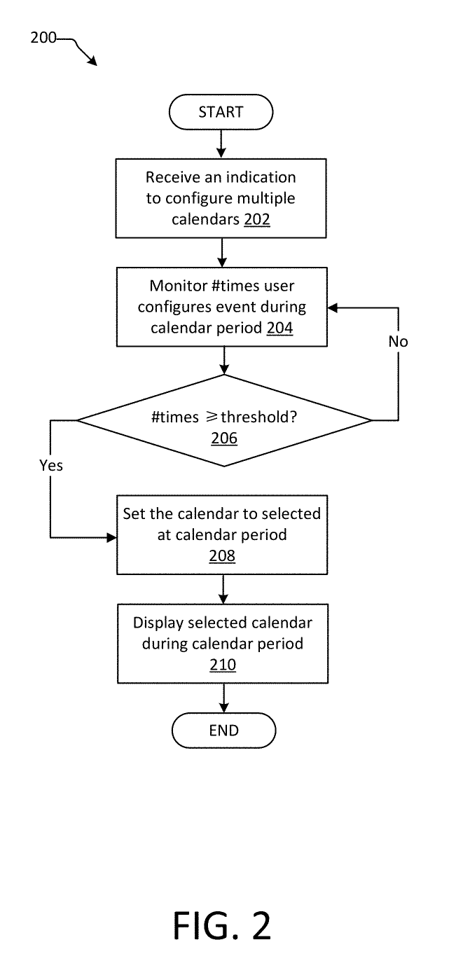

FIG. 2 illustrates a method for automatically displaying one or more calendars during a calendar period based on monitoring user-configured calendar events for calendar period, according to an example embodiment.

At receive operation 202, similar to receive operation 102, an indication to configure multiple calendars may be received.

At monitor operation 204, similar to monitor operation 104, user interactions with one or more calendars of the multiple calendars may be monitored. However, in this case, a number of occurrences in which a user configures an event during a calendar period on a particular calendar may be monitored. That is, the number of times a user configures a calendar event on a particular calendar at a particular time may be monitored. For example, a user may configure a recurring calendar event for a particular calendar on Mondays at 5 PM, or a user may routinely configure a calendar event for a doctor's appointment on the first Tuesday of every month, etc. In this case, the time period during which the user configures the event (i.e., inputs the event) may not be monitored, but rather the calendar period during which the event is set to occur in a particular calendar. Typically, a user would configure events that are of interest to the user. It would be helpful to the user to automatically display the appropriate calendar during the calendar period associated with such repeated events.

At determination operation 206, the number of times a user configured an event during a calendar period may be compared to a threshold value. The threshold value may be any suitable number suggesting that a user is interested in a particular calendar during a particular calendar period (e.g., configuring an event three times, five times, etc.). The threshold value may be preset by the system or selected by a user and may be stored by the system. If the number is greater than or equal to the threshold value, then the method may proceed to set operation 208. If the number is less than the threshold value, the method may return to monitor operation 204.

At set operation 208, when the number of event configurations is greater than or equal to the threshold value, a calendar may be selected for display during the associated calendar period.

At display operation 210, calendars selected for display are displayed during a particular calendar period. For example, when a user has configured a recurring calendar event for a particular calendar on Mondays at 5 PM, the particular calendar may be selected for display on Mondays at 5 PM. In another example, when a user has configured a calendar event on the first Tuesday of every month, the particular calendar may be selected for display on the first Tuesday of every month.

As should be appreciated, operations 202-210 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

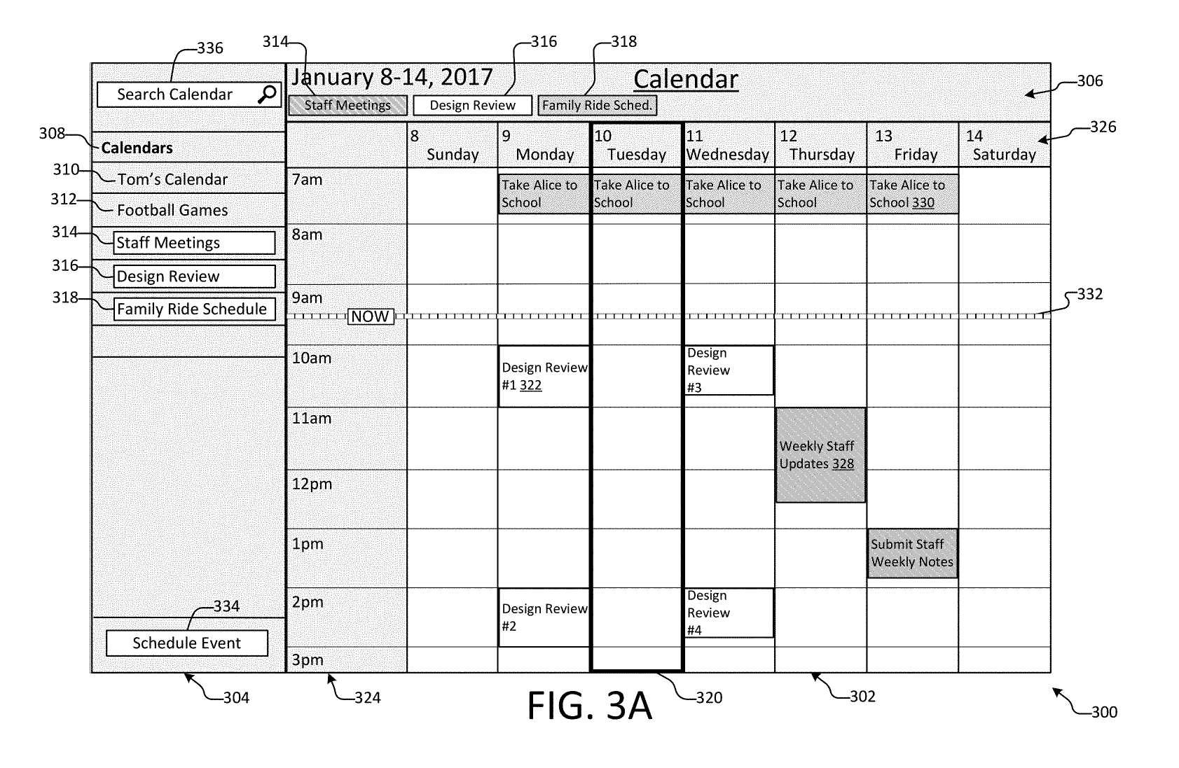

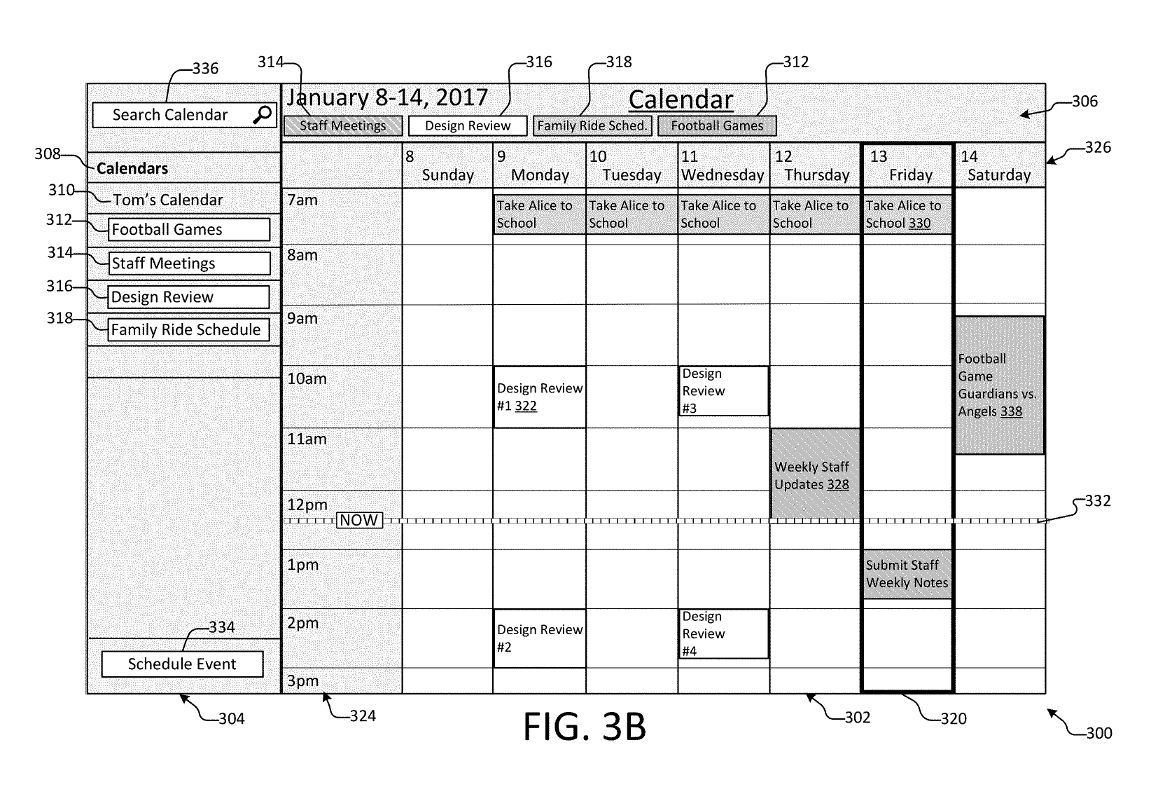

FIG. 3A depicts a graphical user interface 300 displaying multiple calendars 308, according to an example embodiment. Interface 300 includes a calendar pane 302, a list pane 304, a header 306, a time scale 324 and a date scale 326. The interface 300 shows an example weekly calendar for a period between Jan. 8, 2017, and Jan. 14, 2017. In the list pane 304, multiple calendars 308 are listed for a user. In the illustrated example, five calendars are identified in list pane 304, of which three are selected (e.g., identified by highlighting) and two are not selected for display within calendar pane 302. In aspects, one or more of the multiple calendars 308 may be manually selected by a user or automatically selected by an application (e.g., calendar management application).

As illustrated, three calendars are identified as selected (e.g., highlighted), e.g., a first calendar 314 entitled “Staff Meetings,” a second calendar 316 entitled “Design Review,” and a third calendar 318 entitled “Family Ride Schedule.” Alternatively, two calendars are not identified as selected (e.g., not highlighted), e.g., a fourth calendar 310 entitled “Tom's Calendar” and a fifth calendar 312 entitled “Football Games.” Further, header 306 identifies the three selected calendars displayed within calendar pane 302, i.e., the first calendar 314, second calendar 316, and third calendar 318. In aspects, selected calendars may be associated with different colors or may be otherwise differentiated, e.g., by different fill patterns, different types of highlighting, different opacity, different levels of grayscale, different border line weights, and the like. As illustrated, the current day, i.e., Tuesday, Jan. 10, 2017, is identified by bold ribbon 320.

Each event is indicated by a block inside the date/time grid, which is associated with a particular day based on date scale 326 and extends from a start time to an end time based on time scale 324. For example, a first event 322 entitled “Design Review #1” was scheduled from 10 AM to 11 AM on Monday, January 9, and a second event 328 entitled “Weekly Staff Updates” is scheduled from 11 AM to 12:30 PM on Thursday, January 12. Additionally, a block associated with the first event 322 is provided in the same color as second calendar 316 (e.g., white) and a block associated with the second event 328 is provided in the same color as the first calendar 314 (e.g., hashed grayscale). Additionally, a third event 330 entitled “Take Alice to School” is scheduled from about 7:10 AM to about 7:45 AM on Friday, January 13. A block associated with the third event 330 is provided in the same color as the third calendar 318 (e.g., dark grayscale). A horizontal bar 332 entitled “NOW” indicates a current time, which is at 9:30 AM on Tuesday, January 10. Interface 300 further provides options for scheduling an event by selecting control 334 and/or searching the calendar via search field 336.

FIG. 3B also depicts graphical user interface 300 displaying multiple calendars 308, according to an example embodiment. Interface 300 includes calendar pane 302, list pane 304, header 306, time scale 324 and date scale 326. The interface 300 shows an example weekly calendar for a period between Jan. 8, 2017, and Jan. 14, 2017. However, in this case, the current day is Friday, January 13, as indicated by bold ribbon 320, and the current time is 12:30 PM, as indicated by horizontal bar 332.

As illustrated by FIG. 3A, list pane 304 identifies multiple calendars 308 for the user. However, as illustrated by FIG. 3B, an additional calendar has been selected for display, i.e., fifth calendar 312 entitled “Football Games” (now highlighted in list pane 304). In this case, header 306 identifies four selected calendars displayed within calendar pane 302, i.e., the first calendar 314, second calendar 316, third calendar 318 and fifth calendar 312. Further, a fourth event 338 entitled “Football Game Guardians vs. Angels” is displayed in a time slot starting at 9:15 AM and ending at 11:30 AM on Saturday, Jan. 14, 2017. A block associated with the fourth event 338 is provided in the same color as indicated for the fifth calendar 312 (e.g., pattern light grayscale).

In some examples, the fifth calendar 312 may be automatically selected based on monitoring user interactions with the calendar, such as, but not limited to, opening the fifth calendar 312 and/or modifying, adding, or deleting an event associated with the fifth calendar 312 (e.g., interacting with the fifth calendar 312 a threshold number of times during a monitored period). In some examples, a calendar may be selected for display after monitoring user interactions associated with search engines (e.g., searching topics that are related to the calendar) and/or other applications (e.g., a messaging application for sending a message related to the calendar). As described above, according to aspects, patterns of user behavior may be identified based on the monitored user interactions during different time periods and one or more rules may then be generated based on the patterns of user behavior. By applying the rules to the multiple calendars it may be determined which calendars are likely to be applicable to the user at different time periods. That is, calendars that satisfy various conditions associated with the rules are likely to be of higher priority to the user and may automatically be selected for display at different time periods.

As should be appreciated, the various methods, devices, components, etc., described with respect to FIGS. 3A and 3B are not intended to limit the systems and methods to the particular components described. Accordingly, additional topology configurations may be used to practice the methods and systems herein and/or some components described may be excluded without departing from the methods and systems disclosed herein.

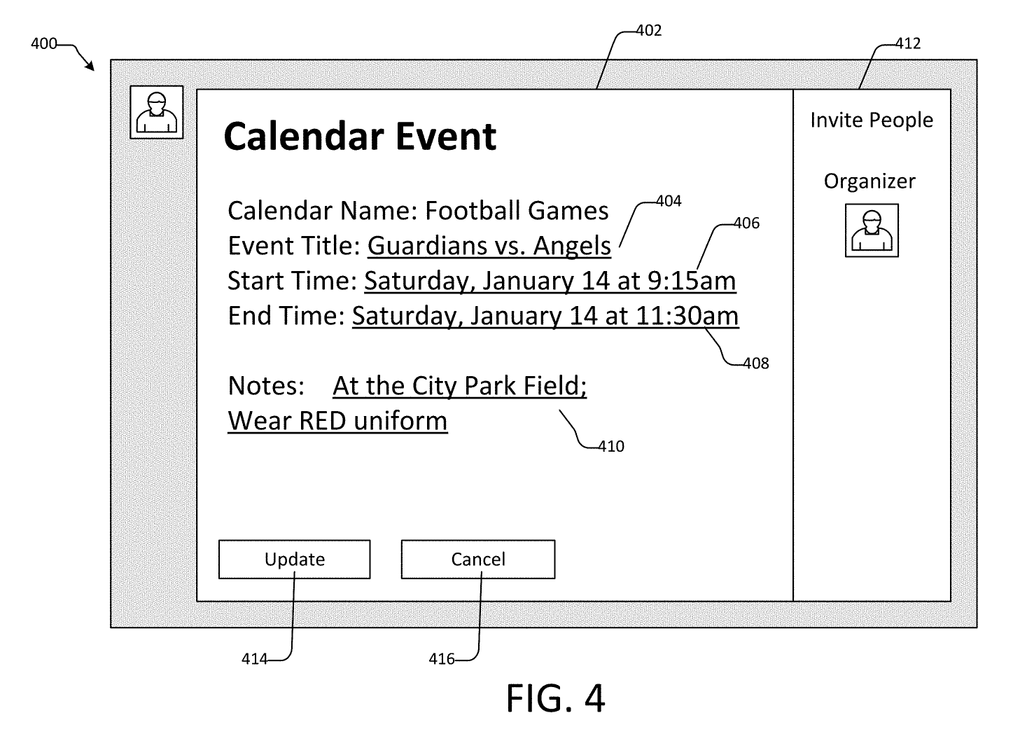

FIG. 4 illustrates a graphical user interface 400 for displaying and updating a calendar event, according to an example embodiment.

In aspects, interface 400 provides one or more fields associated with an event entry 402 entitled “Guardians vs. Angels” associated with calendar “Football Games.” As detailed above, each calendar of multiple calendars may be associated with one or more events. A calendar event (or “event”) may include an appointment, a reminder, a meeting, a social activity, a sporting activity, a work trip, a personal vacation, and the like. In aspects, an event may include a title (e.g., provided in title field 404 of the event entry 402), a start time (e.g., provided in start field 406) and an end time (e.g., provided in end field 408). Additionally, an event may include associated notes about the event (e.g., provided in note field 410). In the illustrated example, the event starts at 9:15 AM on Saturday, January 14, and ends at 11:30 AM on the same date. Notes regarding the event indicate that the football game is to be held at the City Park Field, and reminds the user to wear the RED uniform.

In aspects, when a user accesses an event associated with a particular calendar (e.g., opens an event entry interface, views an event, modifies an event, adds an event, deletes an event, etc.), the time that the user accesses the particular calendar and/or the calendar period associated with the event may be logged. In this way, user behavior with respect to various events in various calendars during particular time periods (e.g., monitored time periods and/or calendar time periods) may be monitored. Based on the user behavior, an appropriate subset (e.g., one or more) of multiple calendars may be displayed automatically at appropriate times.

As should be appreciated, the various methods, devices, components, etc., described with respect to FIG. 4 are not intended to limit the systems and methods to the particular components described. Accordingly, additional topology configurations may be used to practice the methods and systems herein and/or some components described may be excluded without departing from the methods and systems disclosed herein.

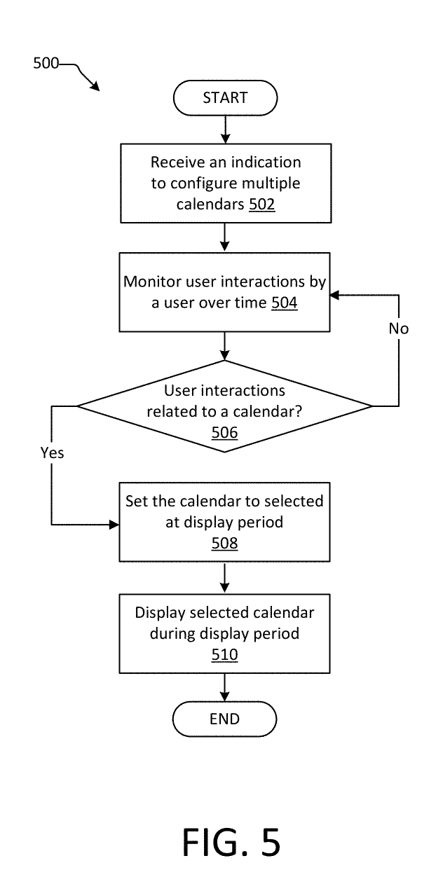

FIG. 5 illustrates a method 500 to selectively display calendars based on user interactions with computing devices. For example, such user interactions may include conducting web searches, interacting with software applications, etc. In this case, the user interactions may be with a web browser or software applications other than a calendaring application (e.g., task applications, messaging applications, productivity applications, customer relationship management applications, line of business applications, and the like).

At receive operation 502, similar to receive operations 102 and 202, an indication to configure multiple calendars may be received.

At monitor operation 504, one or more user interactions may be monitored over time. For instance, user interactions such as conducting one or more web searches and/or interacting with one or more software applications may be monitored over time. That is, a time associated with the user interaction (e.g., the time that a user conducted a search, accessed a software application, etc.) and/or a time associated with a topic of the user interaction (e.g., a time associated with an event that was searched) may be identified. For example, if a user often conducts a search for movies and/or accesses an entertainment application on Thursday evenings, a search time associated with the search (i.e., Thursday evenings) may be logged. Alternatively, if a user conducts a search regarding a sporting event scheduled for Aug. 4, 2017, an event time associated with the search may be Aug. 4, 2017. In some aspects, a search time and an event time may be logged for a particular search. In another aspect, a user may interact with a messaging application and may send a message to a personal or business contact regarding scheduling a lunch this Friday. In this case, the message may be associated with a message time (e.g., the time that the messaging application was accessed and/or the message was sent) and/or an event time (e.g., the time associated with the lunch referred to in the message). As should be appreciated, the above examples are provided for purposes of explanation and are not intended to be limiting.

At determination operation 506, it may be determined whether the user interaction is related to a calendar during a time period. If the user interaction is a web search, it may be determined whether the topic searched is related to a particular calendar. For instance, if the topic searched was a sporting event and the user maintains a “Sports” calendar, it may be determined that the user interaction is related to the “Sports” calendar. Additionally, if the sporting event is associated with an event time of Friday, Aug. 4, 2017, it may be determined that the “Sports” calendar may be applicable to the user on or about Friday, Aug. 4, 2017. Additionally or alternatively, the content of webpages searched may be evaluated to determine whether a search is related to a particular calendar. For instance, if a user browsed a number of travel websites (e.g., websites for airlines, hotels, cruise ships, vacation packages, etc.), it may be determined that the search is related to a “Personal” calendar. The search may further be associated with a search time and/or an event time. For instance, it may be determined that the “Personal” calendar is applicable to the user while the search is being performed and/or during a time associated with dates searched on the travel websites (e.g., June 5-June 25).

Alternatively, at determination operation 506, if the user interaction is sending or receiving a message, it may be determined whether the recipient (or sender) of the message and/or the topic of the message is related to a particular calendar. For instance, if the message was sent to (or received from) a business contact, it may be determined that the message is related to a “Work” calendar. Alternatively, if the message was sent to (or received from) a personal contact, it may be determined that the message is related to a “Personal” calendar. Additionally or alternatively, based on the content of the message, it may be determined whether the message is related to a particular calendar. For instance, if the message is related to carpooling to a football game on Saturday, it may be determined that the message is related to a “Sports” calendar and that the “Sports” calendar may be applicable to the user on or about Saturday. In some cases, a user interaction may be related to more than one calendar (e.g., a “Personal” calendar and a “Sports” calendar). If it is determined that the user interaction is related to a calendar, the method may proceed to select operation 508. If it is determined that the user interaction is not related to a calendar, the method may return to monitor operation 504.

At select operation 508, when it is determined that a user interaction is related to one or more calendars, the one or more calendars may be selected for display. Additionally, based on a time associated with the user interaction (e.g., a search time, a message time, an event time, etc.), the one or more calendars may be selected for display during a display period corresponding to a time associated with the user interaction. In some cases, the one or more calendars may be selected for display over more than one display period (e.g., a first display period corresponding to the search time and a second display period corresponding to the event time).

At display operation 510, the one or more selected calendars may be displayed to a user. In aspects, if multiple calendars are selected, display of the multiple selected calendars may be merged, overlaid, or otherwise combined such that the user may be able to view events associated with each of the selected calendars substantially simultaneously.

As should be appreciated, operations 502-510 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

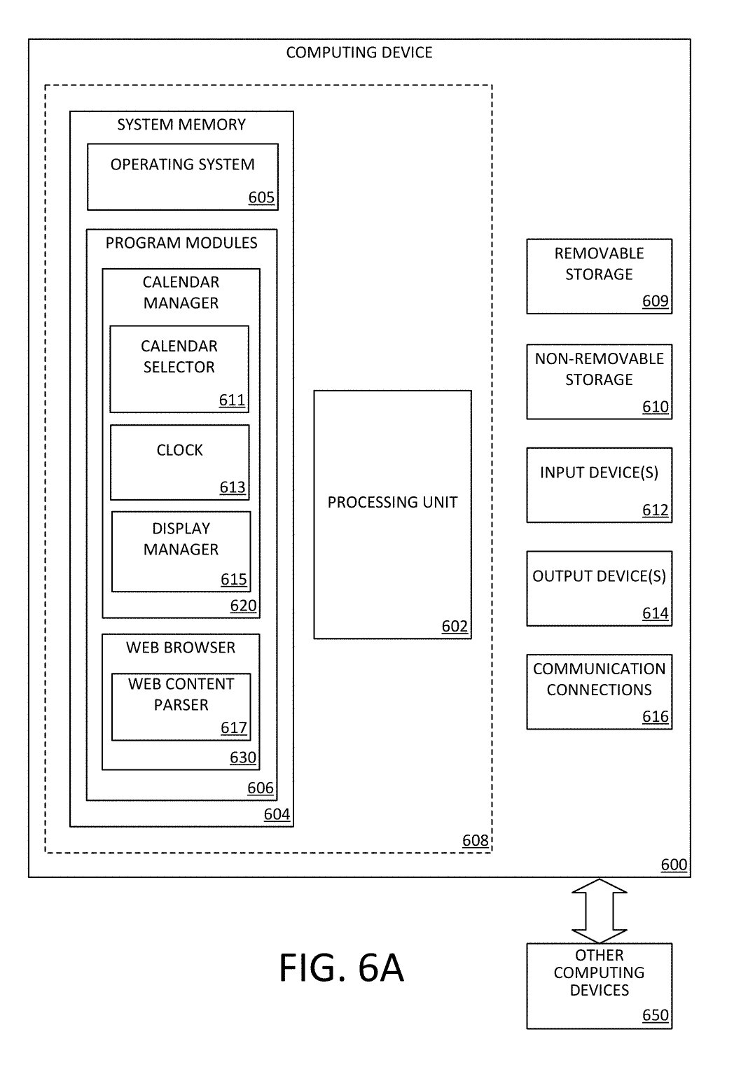

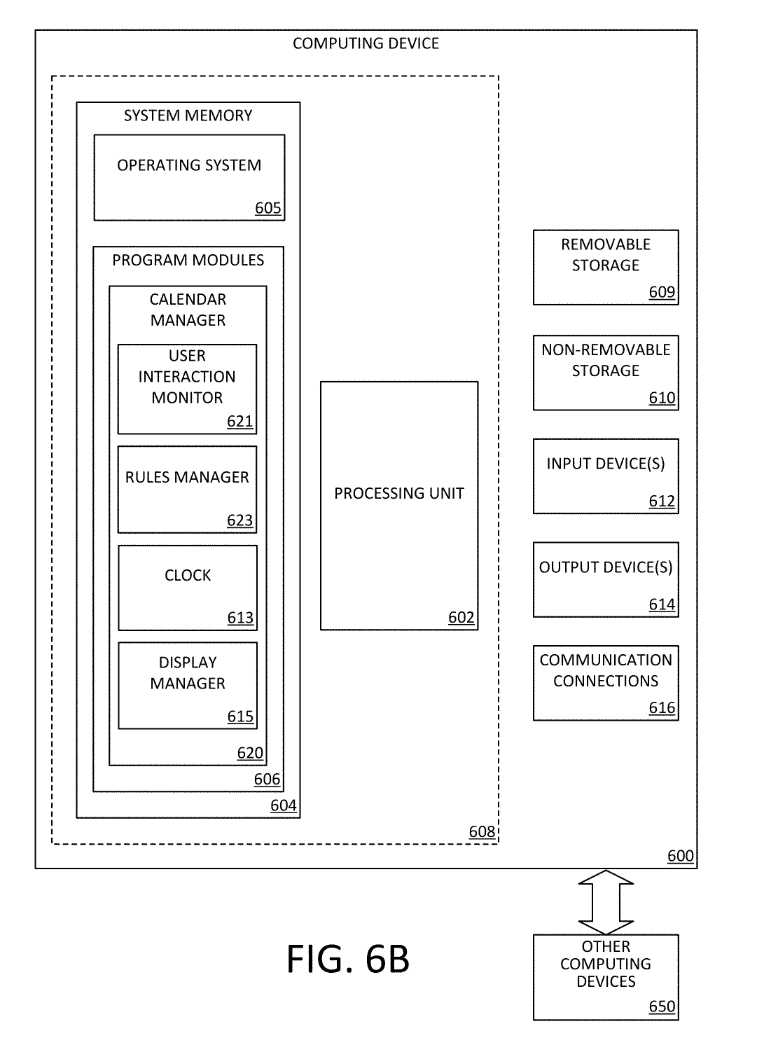

FIGS. 6A-9 and the associated descriptions provide a discussion of a variety of operating environments in which aspects of the disclosure may be practiced. However, the devices and systems illustrated and discussed with respect to FIGS. 6A-9 are for purposes of example and illustration and are not limiting of a vast number of computing device configurations that may be utilized for practicing aspects of the disclosure, described herein.

FIGS. 6A and 6B are block diagrams illustrating physical components (e.g., hardware) of a computing device 600 with which aspects of the disclosure may be practiced. The computing device components described below may have computer executable instructions for implementing a consensus determination application 620 on a computing device, including computer executable instructions for consensus determination application 620 that can be executed to implement the methods disclosed herein. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for performing the various aspects disclosed herein. For example, the one or more program modules 606 may include a Calendar Manager 620 for managing display of one or more calendars.

As illustrated by FIG. 6A, Calendar Manager 620 may include one or more components, including a Calendar Selector 611 for automatically selecting specific calendars for display at specific times, a Clock 613 for maintaining the current time, and a Display Manager 615 for managing display of one or more calendars and events. As illustrated by FIG. 6A, Calendar Manager 620 may have access to a Web Browser 630, which may include or be associated with a Web Content Parser 617 to parse search terms and/or web contents for determining whether a search is related to one or more calendars. Alternatively, as illustrated by FIG. 6B, Calendar Manager 620 may include one or more alternative components. For example, rather than including a Calendar Selector 611, Calendar Manager 620 may include a User Interaction Monitor 621 for monitoring user interactions (e.g., with calendar applications, search engines, and/or other software applications) and a Rules Manager 623 for identifying patterns associated with the monitored user interactions and generating rules for displaying calendars based on the patterns. In this example, Calendar Manager 620 may further include Clock 613 for maintaining the current time and Display Manager 615 for managing display of one or more calendars and events. In further examples, the one or more components described with reference to FIGS. 6A and 6B may be combined on a single computing device 600 or multiple computing devices 600.

The operating system 605, for example, may be suitable for controlling the operation of the computing device 600. Furthermore, embodiments of the disclosure may be practiced in conjunction with a graphics library, other operating systems, or any other application program and is not limited to any particular application or system. This basic configuration is illustrated in FIGS. 6A and 6B by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIGS. 6A and 6B by a removable storage device 609 and a non-removable storage device 610.

As stated above, a number of program modules and data files may be stored in the system memory 604. While executing on the processing unit 602, the program modules 606 (e.g., Calendar Manager 620) may perform processes including, but not limited to, the aspects, as described herein. Other program modules that may be used in accordance with aspects of the present disclosure, and in particular for managing display of multiple calendars, may include Calendar Selector 611, Clock 613, Display Manger 615, User Interaction Monitor 621, Rules Manager 623, Web Browser 630, and/or Web Content Parser 617, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIGS. 6A and 6B may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As should be appreciated, FIGS. 6A and 6B are described for purposes of illustrating the present methods and systems and are not intended to limit the disclosure to a particular sequence of steps or a particular combination of hardware or software components.

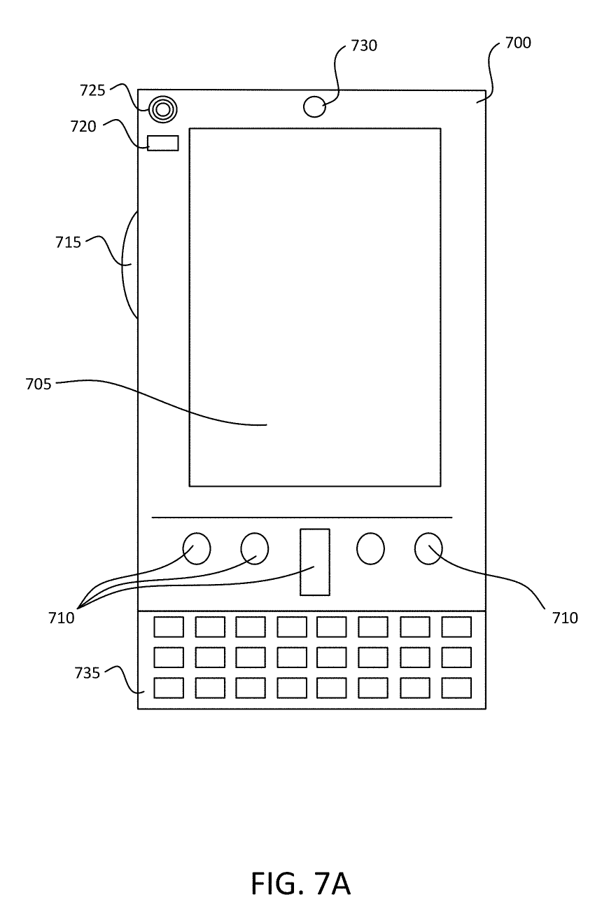

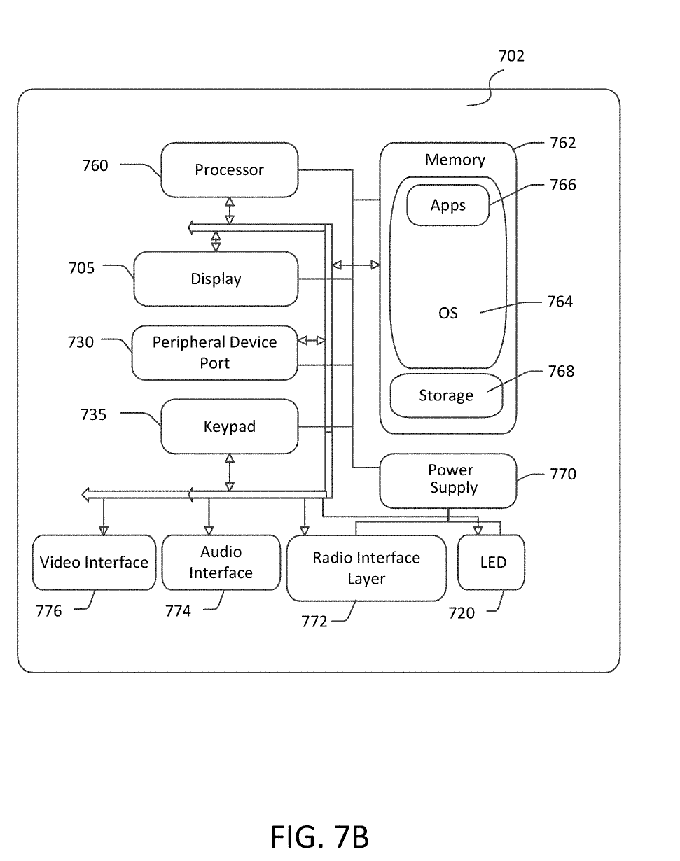

FIGS. 7A and 7B illustrate a mobile computing device 700, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as email or other messages used by an email application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including the instructions for providing a consensus determination application as described herein (e.g., message parser, suggestion interpreter, opinion interpreter, and/or consensus presenter, etc.).

The system 702 has a power supply 770, which may be implemented as one or more batteries. The power supply 770 may further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via an audio transducer 725 (e.g., audio transducer 725 illustrated in FIG. 7A). In the illustrated embodiment, the visual indicator 720 is a light emitting diode (LED) and the audio transducer 725 may be a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of peripheral device 730 (e.g., on-board camera) to record still images, video stream, and the like. Audio interface 774, video interface 776, and keypad 735 may be operated to generate one or more messages as described herein.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

As should be appreciated, FIGS. 7A and 7B are described for purposes of illustrating the present methods and systems and are not intended to limit the disclosure to a particular sequence of steps or a particular combination of hardware or software components.

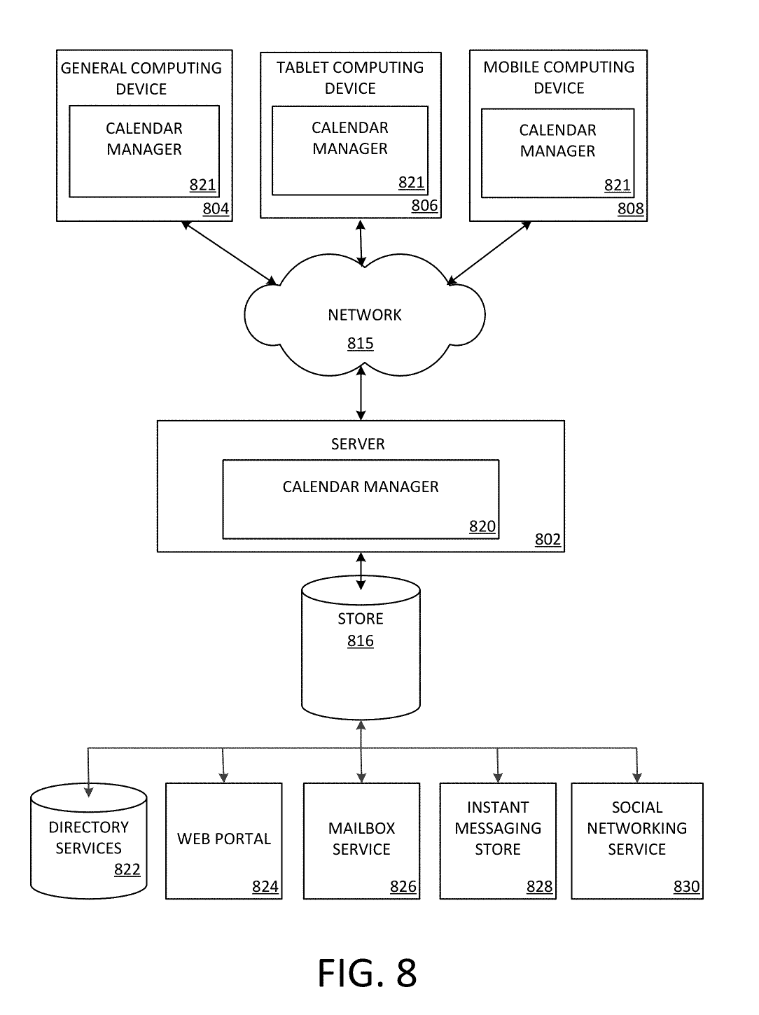

FIG. 8 illustrates one aspect of the architecture of a system for processing data received at a computing system from a remote source, such as a general computing device 804 (e.g., personal computer), tablet computing device 806, or mobile computing device 808, as described above. Content displayed at server device 802 may be stored in different communication channels or other storage types. For example, various messages may be received and/or stored using a directory service 822, a web portal 824, a mailbox service 826, an instant messaging store 828, or a social networking service 830. The calendar manager 821 may be employed by a client that communicates with server device 802, and/or the calendar manager 820 may be employed by server device 802. The server device 802 may provide data to and from a client computing device such as a general computing device 804, a tablet computing device 806 and/or a mobile computing device 808 (e.g., a smart phone) through a network 815. By way of example, the computer system described above with respect to FIGS. 1-5 may be embodied in a general computing device 804 (e.g., personal computer), a tablet computing device 806 and/or a mobile computing device 808 (e.g., a smart phone). Any of these embodiments of the computing devices may obtain content from the store 816, in addition to receiving graphical data useable to either be pre-processed at a graphic-originating system or post-processed at a receiving computing system.

As should be appreciated, FIG. 8 is described for purposes of illustrating the present methods and systems and is not intended to limit the disclosure to a particular sequence of steps or a particular combination of hardware or software components.

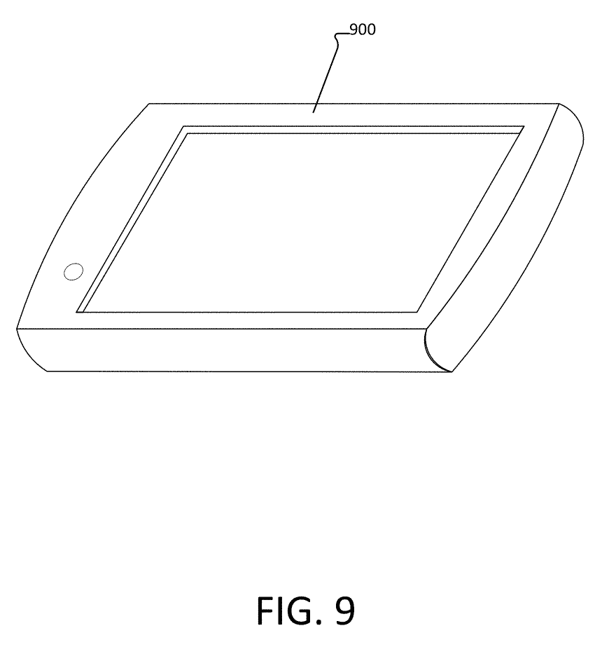

FIG. 9 illustrates an exemplary tablet computing device 900 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As should be appreciated, FIG. 9 is described for purposes of illustrating the present methods and systems and is not intended to limit the disclosure to a particular sequence of steps or a particular combination of hardware or software components.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A computer-implemented method of selectively displaying one or more calendars, the method comprising:
receiving an indication to configure a plurality of calendars, wherein each calendar is associated with one or more events;
monitoring one or more user interactions over a monitored period of time;
generating at least one rule based at least in part on the monitored one or more user interactions over the monitored period of time; and
based at least in part on the at least one rule, selecting at least one of the plurality of calendars for display over a display period.

2. The computer-implemented method of claim 1, wherein the monitored period of time includes one or more increments of time.

3. The computer-implemented method of claim 2, wherein the one or more increments of time comprise at least one of:
late-night hours on a weekday;
evening hours on a weekday;
daytime hours on a weekday;
morning hours on a weekday;
early morning hours on a weekday;
late-night hours on a weekend day;
evening hours on a weekend day;
daytime hours on a weekend day;
morning hours on a weekend day; and
early morning hours on a weekend day.

4. The computer-implemented method of claim 2, wherein the one or more increments of time comprise any measurable time period.

5. The computer-implemented method of claim 1, wherein the monitored period of time is a continuous period of time.

6. The computer-implemented method of claim 1, wherein the one or more user interactions comprise one or more of:
a user interaction with a calendar;
a user interaction with an event associated with a calendar;
a user interaction with a search engine;
a user interaction with a messaging application;
a user interaction with a customer relationship management application;
a user interaction with a line-of-business application; and
a user interaction with a productivity application.

7. The computer-implemented method of claim 1, further comprising:
determining whether the one or more user interactions are related to a calendar.

8. A computing system, comprising:
at least one processor; and
at least one memory storing computer-executable instructions that when executed by the processor cause the computing system to:
monitor a number of user interactions with at least one calendar of a plurality of calendars over a monitored time period;
determine whether the number of user interactions during the monitored time period is greater than or equal to a threshold; and
when the number of user interactions is greater than or equal to the threshold, select the at least one calendar of the plurality of calendars for display over a display period.

9. The computing system of claim 8, wherein the display period corresponds to the monitored time period.

10. The computing system of claim 8, wherein the monitored time period includes one or more increments of time.

11. The computing system of claim 8, wherein the threshold is selected by one of a user and the computing system.

12. The computing system of claim 10, wherein the one or more increments of time comprise at least one of:
late-night hours on a weekday;
evening hours on a weekday;
daytime hours on a weekday;
morning hours on a weekday;
early morning hours on a weekday;
late-night hours on a weekend day;
evening hours on a weekend day;
daytime hours on a weekend day;
morning hours on a weekend day; and
early morning hours on a weekend day.

13. The computing system of claim 10, wherein the one or more increments of time comprise any measurable time period.

14. The computing system of claim 8, wherein the monitored time period is a continuous time period.

15. The computing system of claim 8, wherein the one or more user interactions comprise one or more of:
a user interaction with a calendar;
a user interaction with an event associated with a calendar;
a user interaction with a search engine;
a user interaction with a messaging application;
a user interaction with a customer relationship management application;
a user interaction with a line-of-business application; and
a user interaction with a productivity application.

16. The computing system of claim 8, the computer-executable instructions further causing the computing system to:
determine whether the one or more user interactions are related to the at least one calendar of the plurality of calendars.

17. A computer storage medium comprising computer-executable instructions that when executed by a processor perform a method of selectively displaying one or more calendars, the method comprising:
receiving an indication to configure a plurality of calendars;
monitoring one or more user interactions over a monitored time period;
determining whether the one or more user interactions are related to at least one calendar of the plurality of calendars; and
based at least in part on determining that the one or more user interactions are related to the at least one calendar, selecting the at least one calendar for display over a display period.

18. The computer storage medium of claim 17, wherein the one or more user interactions comprise one or more of:
a user interaction with a calendar;
a user interaction with an event associated with a calendar;
a user interaction with a search engine;
a user interaction with a messaging application;
a user interaction with a customer relationship management application;
a user interaction with a line-of-business application; and
a user interaction with a productivity application.

19. The computer storage medium of claim 18, wherein the monitored time period comprises at least one of:
late-night hours on a weekday;
evening hours on a weekday;
daytime hours on a weekday;
morning hours on a weekday;
early morning hours on a weekday;
late-night hours on a weekend day;
evening hours on a weekend day;
daytime hours on a weekend day;
morning hours on a weekend day; and
early morning hours on a weekend day.

20. The computer storage medium of claim 18, wherein the display period corresponds to the monitored time period.
